(19) United States
(12) Patent Application Publication
(10) Pub. No.: US 2006/0218636 A1
(43) Pub. Date: Sep. 28, 2006

(54) Distributed communication security systems

(76) Inventor: David Chaum, Sherman Oaks, CA (US)

Correspondence Address: David Chaum, 14652 Sutton St., Sherman Oaks, CA, 91403, US

(21) Appl. No.: 11/388,520

(22) Filed: Mar. 24, 2006

Related U.S. Application Data
(60) Provisional application No. 60/664,805, filed on Mar. 24, 2005.

(51) Int. Cl. G06F 12/14

(52) U.S. Cl. 726/22

(57) ABSTRACT

Solutions to the so-called “man in the middle” problem are disclosed. One example uses a mutually-random value that is the same for each of two communicants absent a man in the middle, but differs between the communicants in case a man-in-the-middle is present. Communicants become aware if their random values differ, for example, through stock content inserted into the communication stream, interactive games, or derived limitations on the channel. In other examples, opening of encrypted parts of the communication is delayed until certain other communication takes place and/or is imminent. In still further examples, a man in the middle becomes apparent because of increased latency of communication between the participants and the effect is optionally accentuated through mutually-random values that shift latency. Further aspects allow parties to apply authentication related to participants they have communicated with when they were convinced that no man in the middle was present. In some examples such communication between common participants is also applied and/or information about the origin of authentication information is hidden.

### BACKGROUND OF THE INVENTION

1. Field of the Invention

The present invention relates generally to communication security systems, and more specifically to addressing man-in-the-middle attacks in such systems.

2. Description of Prior Art

The present application claims priority from a United States Provisional Application, by the present applicant, titled “Distributed Communication Security,” U.S. PTO 60/664805, which is hereby included here in its entirety by reference.

The so-called “man in the middle” problem is typically defined in the context of two entities communicating using encryption to protect the content of information they exchange. The problem arises as they are not sure whether they are in fact using each others key—as should be the case—or whether each is being tricked into using a key of an intermediary that has inserted itself between them and decrypts messages received from one party before reading, and possibly modifying them, and then re-encrypting them for the other party.

Prior art solutions due to Rivest and Shamir involve the parties being able to recognize each others voices and preparing messages that are exchanged at the same time, in a so-called “interlock protocol.” They also proposed receiving a response to an encrypted message during a fixed time interval. These systems pose unattractive and impractical requirements and use-paradigms and their lack of applicability is born out by their lack of adoption. Also known are explicit exchange of so-called “key fingerprint” digits and publication of so-called “key rings” in the so-called “PGP” system. Not only are these systems inconvenient, and require noticeable effort, but a man in the middle can in principle edit the voice digit snippets and fool the counterparties. Moreover, posting information about associations of communicants may be undesirable at least in terms of privacy. Attention to and adoption of these techniques, however, bears out the significance of the need for improved solutions to the problem.

The present invention aims, accordingly and among other things, to provide improved systems to address the possibility man in the middle attacks. Objects of the invention also include addressing all the above mentioned as well as generally providing practical, robust, efficient, low-cost, convenient, secure, unobtrusive, adaptable, and/or optionally entertaining solutions. All manner of apparatus and methods to achieve any and all of the forgoing are also included among the objects of the present invention.

Other objects, features, and advantages of the present invention will be appreciated more fully when the present description and appended claims are read in conjunction with the drawing figurers.

### BRIEF DESCRIPTION OF THE DRAWING FIGURES

FIG. 1 is a combination block, functional, protocol, schematic, flow, plan diagram of exemplary overall systems in accordance with the teachings of the present invention.

FIG. 2 is a combination block, functional, protocol, schematic, flow, plan diagram of exemplary random data systems in accordance with the teachings of the present invention.

FIG. 3 is a combination block, functional, protocol, schematic, flow, plan diagram of exemplary random communication pattern systems in accordance with the teachings of the present invention.

FIG. 4 is a combination functional, protocol, schematic, flow, plan diagram of exemplary communication order systems in accordance with the teachings of the present invention.

FIG. 5 is a combination functional, protocol, schematic, flow, plan diagram of exemplary communication timing systems in accordance with the teachings of the present invention.

FIG. 6 is a combination functional, protocol, schematic, flow, plan diagram of exemplary communication latency systems in accordance with the teachings of the present invention.

FIG. 7 is a combination block, functional, protocol, flow, schematic, diagram of exemplary mutual communicant discovery and authentication systems in accordance with the teachings of the present invention.

FIG. 8 is a combination block, functional, protocol, flow, schematic, diagram of exemplary privacy-enhanced mutual communicant discovery systems in accordance with the teachings of the present invention.

FIG. 9 is a combination block, functional, protocol, flow, schematic, diagram of exemplary friend-of-a-friend communicant discovery systems in accordance with the teachings of the present invention.

FIG. 10 is a combination block, functional, protocol, flow, schematic, diagram of exemplary sub-protocols for establishment in accordance with the teachings of the present invention.

FIG. 11 is a combination block, functional, protocol, flow, schematic, diagram of exemplary sub-protocols for proof to convince of transformation correctness in accordance with the teachings of the present invention.

### BRIEF SUMMARY OF THE INVENTION

This section introduces some of the inventive concepts in a way that will readily be appreciated, but makes significant simplifications and omissions for clarity and should not be taken to limit scope in any way whatsoever; the next section presents a more general view.

One novel example way for two communicant parties to solve the man in the middle problem uses a random value that they create in such a way that they will each get a matching mutually-random number without a man in the middle; but if there is a man in the middle, he will be unable to keep them from getting different numbers. One inventive aspect is a protocol to achieve such random values and others include example ways such a number can affect the communication between the parties so that they will notice if their numbers differ.

An example way to achieve such random numbers involves a mutual random protocol that is unalterably marked by the key pair the communicants intend to use. For instance, a first of the two parties creates a so-called cryptographic commitment to a pair of values: a first random number the first party chooses and the private key the two parties plan to use. Once the second party supplies a second random value, the first party reveals the first random value to the second party. The mutually random value is the combination of the two random values according to a previously agreed method, such as by a cyclic group operation. It is believed that if a man in the middle conducts the protocol separately with each party, each of the first and second parties will be left with a different number as the mutual number, at least with substantially high probability. But if the man in the middle tries to involve each party in a single valid instance of the protocol, the unalterable key in the protocol substantially must be the correct shared key and thereby excludes the man in the middle.

One example way to allow the communicants to become aware if their random values differ is by a common public database of stock content that is selected by the random number at each end of the communication and played locally there. For instance, a joke of the day can be selected from a database of such jokes depending on the random number; each participant sees the same joke overlaid on or in addition to the communication when there is no man in the middle, otherwise they each very likely see a different joke. If the communicants comment or relate their conversation to the joke, a mismatch may become apparent.

Another example is where the random value is used as a kind of coin flip or card draw between the two human participants. For instance, if the two communicants agree to flip a coin to determine where to meet for lunch, half the time they will each show up at different restaurants waiting for the other. Or, using the randomness to determine card draws, the results of a so-called “mental” card game will very likely differ. A further example use of randomness is to structure the communication itself. For instance, a conversation can be divided into minutes and the random value determines which group of minutes will be a break during which neither party can communicate with the other.

A second novel approach is delaying the opening of encrypted parts of the communication until certain other communication takes place. One example is where the encrypted message unalterably tied to the shared key constitutes a first party providing the answer to a riddle or other question. The second party then provides its own guess at the answer to the first party, at which point the first party releases the key to its previously sent answer. Thus the man in the middle is believed unable to provide the first party answer (or at least an undetectable engineered answer) to the second party in advance of the second party guess. A further example is during a series of messages sent back and forth with significant delays in between, such as so-called email or chat. Each message is sent with commitment encryption and the key released to decrypt it only once the counterparty requests it just before replying. When the total amount of time that messages remain encrypted before being opened exceeds half of the elapsed time, it is believed the participants can be sure that there was no time to include the extra delay that would be introduced by a man in the middle.

A third novel approach makes a man in the middle apparent because he is unable to keep from increasing the latency of communication between the participants. People notice the so-called latency or delay in speech caused by the communication system and find it unpleasant and even difficult to converse when the latency is too high. By communicants creating a delay between the sending of an encrypted packet and the release of a unique key for it, the man in the middle is put in a position of having to introduce an additional similar delay, thus increasing the extent to which it is noticeable by the communicants. By shifting the delay gradually from one communicant to the other in a way coordinated by what should be a mutually random value, the so-called “round trip” delay is kept substantially constant; but if each communicant has a different random value, there are substantial times during which they both have the maximum contribution, in effect doubling the latency yet again.

A further novel aspect of the invention allows parties to discover authentication of common participants they have communicated with when they were convinced that no man in the middle was present. In one example authenticators that each of two participants has resulting from communication with a mutual friend are detected and then established as valid. In another example, each communicant receives authenticators from friends that relate to their friends; if the two communicants are thereby connected by a friend-of-a-friend relationship, then this is detected and the validity of the authenticators established. In some instances of the examples the authenticators exchanged are obfuscated so that they do not reveal additional information and, when a connection is discovered, the participants have the option of revealing to each other who the mutual friend or friend of a friends are.

### GENERAL DESCRIPTION

One example application setting, for clarity and without loss of generality, as will be appreciated, includes email communication between two parties. Each of the two parties, A and B, will have their own email encryption proxy C and D, respectively. In such a setting, A receives email from and provides email to C and similarly for B with respect to D, while C and D communicate among themselves typically over a network. Similar remarks apply to other message based communication, such as current so-called instant messaging and voicemail; anticipated is generalization to whatever forms of messaging evolve, such as, for instance, video messaging.

Another example application setting, for clarity and without loss of generality, as will be appreciated, includes so-called “real-time” or “interactive” communication. Current examples include telephone, voice over internet, video conferencing, and so forth; anticipated is generalization to whatever forms of such communication evolve, such as, for instance, three-dimensional and/or avatar interaction.

For clarity, it will be assumed that C and D each have public and private keys for communication with each other. It is an option that there are hashes of these public keys and signatures on hashes of these, preferably arranged in a hash tree structure, the cumulative updated root of which is preferably widely available and signed by multiple parties. In one example, the signatures are made by plural entities having pre-installed public key certificates on client PC's, such as those there for use by browsers.

Mapping this model to various known and/or anticipated configurations and dividing of hardware and software functions can be by a variety of substantially equivalent configurations for the present invention. In some examples, for instance, D and C are processes running on A and B's respective PCs or they can for instance run on other computers, such as servers at A or B's respective organizations or service providers. In some examples, A and B are referred to, as is customary, as if they are the users themselves and/or the email software running on computer(s) used by the users. As will be appreciated, other example configurations are well known and anticipated. One example is where the email software is split between a client and server, whether the server is a single device or is distributed and/or multi-tier. In some examples of such client server setups for email, some software may be provided to run on the client side, such as applets, and it is preferably involved in decryption and/or encryption. In such configurations, the servers may be considered the as the proxy D or C and the client side as A or B. In other example configurations, software substantially integrating the email and proxy functions is considered as a single system.

A general aspect of these systems is the interface between A and C as well as that between B and D optionally includes two types that A and B at least can distinguish. One type is the communication channel proper, through which the text, audio, video or whatever from the counterparty is rendered and corresponding input to be conveyed to the counterparty is received. Another type is communication between A and C (or B and D) about the other communication channel. For instance, the latter meta channel may indicate that the main channel type has been compromised by a man in the middle, or to what extent or for what reasons it is believed not to be. In other examples, the meta data relates to choices allowed the communicant. Sometimes here the options for or preferences related to allocation between the two types are omitted for clarity.

Another general aspect of these systems in multiplicities and persistence of state. It will be appreciated that generally human users are important communicants and that they may use one or more devices and/or systems and/or collections of devices and systems to accomplish their various goals, from time to time. It is preferable, however, that state information related to keys and communicants and what will be referred to as authenticators later be available on a cumulative basis for users. Portable memory hardware and/or virtual network memory services (whether or not bundled with applications) are anticipated. Different techniques may be more attractive for different communication media, however, the confidence gained preferably is aggregated across them.

Still another aspect of these systems are combinations of the various exemplary embodiments disclosed separately. It will be appreciated that various combinations of the embodiments may prove useful at various times and for various purposes. Whatever combinations of the techniques disclosed and their equivalents and variations are anticipated. For instance, the authenticators of FIG. 7-11 preferably draw on what may be established using earlier disclosed embodiments. As just one example, when a user first considers communication with a party, these later techniques are believed to provide at least some initial indication; later, however, further confidence may be established by other techniques.

In some embodiments, what will be called stock “content” or “brighteners” here may, for instance, be in the form of character strings, text, graphics, animations, moving images, three-dimensional images with or without motion, and may include audio. Some examples of brighteners include: copy such as quotes, witticisms, predictions, one-liners, aphorisms, sayings, fortunes, or jokes; graphics, such as photographs, drawings, portraits or cartoons; names or questions or facts, such as those related to films, plays, music, sports, politics or companies; games or puzzles, such as card hands, game board setups, crossword puzzles, computer games; computer generated material, such as word sequences, so-called random art, summaries and/or questions related to earlier email; content supplied by actual users of the email, and so forth and so on.

What will be called here “games” include, without limitation, such things as coin flips, so-called virtual card games, whatever games of chance, and current so-called multi-player video gaming where input from random sources is included; anticipated is generalization to whatever forms of games evolve that include in effect unpredictable input.

In some embodiments, what will be called “commits” and/or “commitments” are encrypted information objects, as are known in the art variously in whatever form, type of underlying assumption, and with whatever key structure. Such commits will be said to be “opened” here to refer to the operation of providing the requisite key material and optionally other parameters to all or part of the information content to be discovered or revealed. Distinction is sometimes made with respect to whether so-called “message recovery” is provided; here, whatever parameters may be needed for the overall system to recover the parts of the information as needed are assumed. It will be appreciated, however, that while the terminology of encryption and commitment are used variously here for clarity, it is preferred that the public key pair of the participants is “entangled” into any such process in a way, such as in the examples shown, that allows the party doing the decryption or opening the commit assurance that they can see/verify the key pair entangled in during encryption/commitment. It is preferable that no known operation preserves the payload of such a transformation while obscuring the key pair.

In some embodiments, the inner workings of communication networks may be relevant. Packet networks today are believed capable of handling real-time communication with acceptable latency. They are being improved in this regard, such as by more attention to the needs for real-time communication. Improvements in processing at each end are also expected to improve overall latency. By way of background, as will be appreciated, a number of considerations are relevant. So-called “jitter buffers” are typically used to increase quality of packet voice. It is believed that round trip delay “affects the natural conversation interactivity, and causes hesitation and over-talk.” And also that delay becomes noticeable when it exceeds 150 ms. ITU-T G.114 “One-way transmission time,” ITU-T Recommendation G.114, May, 2000 specifies the maximum desired round-trip delay as 300 ms. It is also believed that “delay over 500 ms will make phone conversation impractical.” As digital networks improve quality of service for real-time communication and endpoints develop more time-efficient codecs and local buffering, the amount of latency that can be added to detect a man in the middle can be expected to rise, as the maximum introduced otherwise becomes smaller. Latency is beloved particularly noticeable in situations such as: short interjections by one speaker while the other speaker continues on or simultaneous speech or when one speaker attempts to interrupt another or when speech otherwise collides. According to the literature on so-called “on-off” patterns, speakers are believed sensitive to a relatively narrow silence interval bounded above by about 200 ms that are used to signal the potential end of a talksprut and that a speaker is willing to allow the other speaker to take over.

### DETAILED DESCRIPTION OF PREFERRED EMBODIMENTS

Detailed descriptions are presented here sufficient to allow those of skill in the art to use the exemplary preferred embodiments of the inventive concepts.

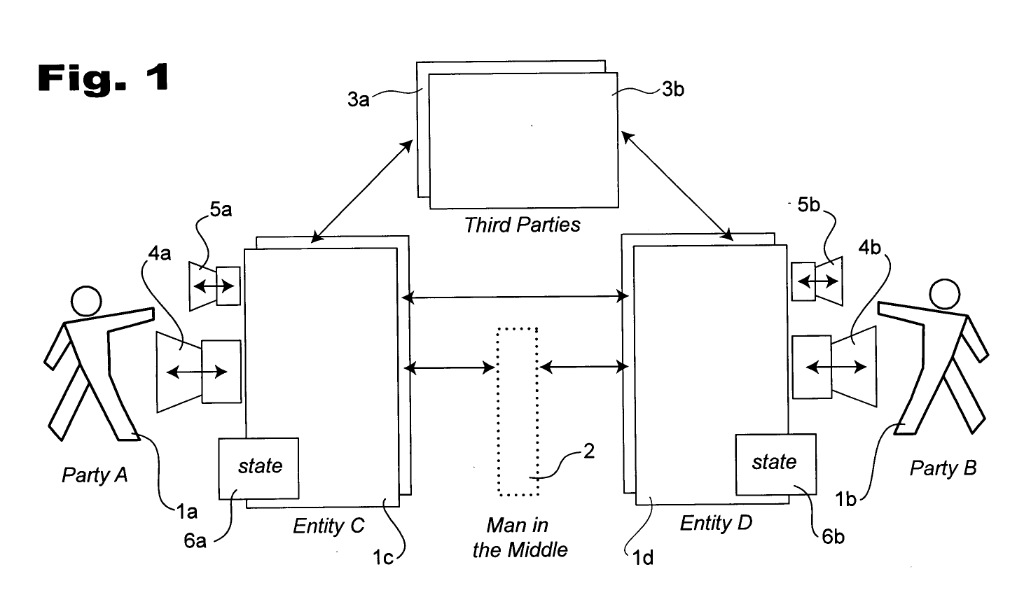

Turning now to FIG. 1 a combination block, functional, protocol, schematic, flow, plan diagram of exemplary overall systems in accordance with the teachings of the present invention will now be described in detail. Shown are several example parties, devices, interfaces, intermediaries and other entities, in various multiplicities.

Party 1a, also referred to as party A for clarity and by convention, is shown as a person; similarly, an example counterparty for communication, party 1b, also referred to herein as party B. The parties A and B are able to interface to input output device 4a and 4b, respectively, through which they communicate with each other, such as by audio, video, text, and so forth. Such communication is shown through entity C, 1c, and entity D, where each is preferably the representative, agent, or device of parties A and B, respectively. Various state related to each party is optionally stored in potentially removable or otherwise portable storage state 6a and 6b, by parties A and B, respectively. Additionally, input out auxiliary 5a and 5b provide a means for communication between party A and entity C and between party B and entity D, respectively. For instance, such auxiliary communication comprises controls and indicators related to the status and operations of the entities on behalf of their respective parties. Multiple instances of entities C and D are shown to indicate that optionally at least some parties may use more than one entity instance.

The communication between the entities C and D is hoped to be direct, as shown by the upper bi-direction arrow connecting them. However, as will be understood, the possibility of a man-in-the-middle 2 interposed between the communicants is anticipated. The man-in-the-middle 2 is typically assumed in the art to be able to impersonate each entity to the other, including the needed cryptographic transformation, based on separate key pairs the man-in-the-middle 2 has with each of the two entities C and D.

Various third parties 3a and 3b are also included in some embodiments. In one example, a party that both A and B have communicated with on previous occasions and particularly where the absence of a man in the middle was ascertained. As another example, A communicated with party 3a and B communicated with 3b, resulting in a so-called “friend of a friend” configuration.

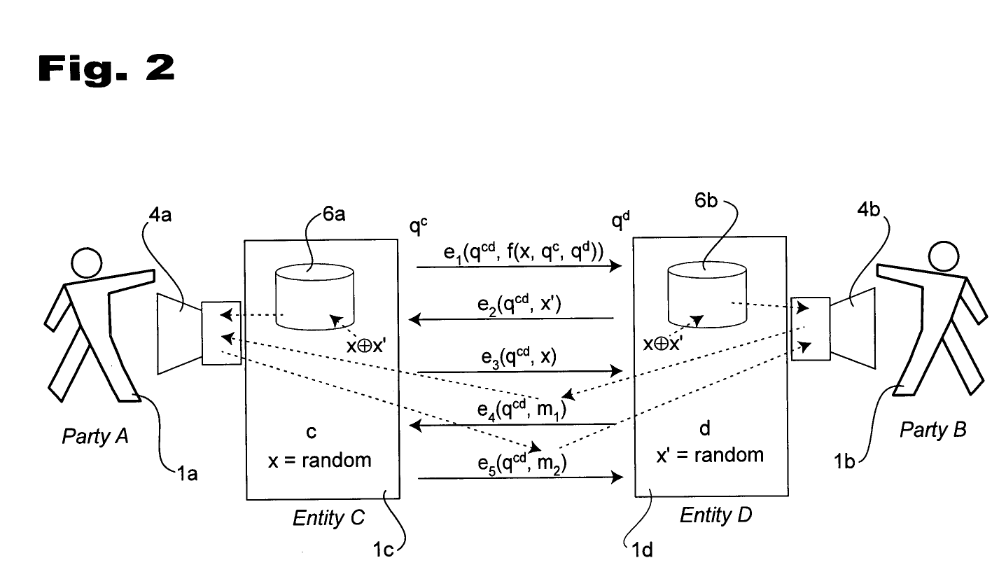

Turning now to FIG. 2, a combination block, functional, protocol, schematic, flow, plan diagram of exemplary random data systems in accordance with the teachings of the present invention will now be described in detail. Shown are the two communicating parties 1a and 1b, referred to here also as A and B for clarity and according to convention. Also shown are their respective devices, entity 1c and 1d, called C and D, here for clarity. Storage/games 6a and 6b are preferably copies of a public database or algorithmic elements that take an input index, along with optionally additional state, and map it into the same sort of output for both C and D, as will be described more fully in the examples. Input output facilities, as mentioned already with reference to FIG. 1, for each device to communicate with its respective user party, 4a and 4b, are shown for parties A and B (out-of-band communication not being shown for clarity).

Public keys, q^{c} and q^{d}, are shown for entity C and D, respectively (while they are denoted as Diffie-Hellman keys, as mentioned below, this will be understood as a known example for clarity and without limitation). For instance, these can are optionally least positive representatives of residue classes modulo a large random integer, preferably with large factors unknown to the participants, such as can be formed by a public process, as is known in the cryptographic art. (Preferable is that the order of the group generated by the public generators q and w, in the examples, are not know.) The corresponding private keys are shown as known to C and D, as c and d, respectively. (Of course multiple public keys per entity are anticipated but not considered for clarity.) Also shown are random number generation facilities for both C and D, such that each is preferably able to create values that are preferably from the desired probability distribution, such as uniform, and preferably substantially independent of each other, and preferably at least substantially difficult for other parties to predict.

Operation through the first three arrows is an example that is optionally applied to a number of particular application scenarios for the subsequent arrows. The first arrow denotes the result of a first encryption operation e₁, performed by C and transmitted by C to D for decryption by D. The encryption operations are parameterized by the subscript message number for clarity and to inhibit re-ordering or other attacks, as is well known. The key material available to the encryption operation is shown, in an illustrative example, but without limitation, as the so-called “Diffie-Hellman” private key that can be determined separately by C and D, as is well know. The first message has a payload that is the output of ƒ, a so-called “one-way function,” being a well-known class of cryptographic primitives and having a variety of known properties and constructions. For the present purpose, such primitives are used to provide a so-called “commit” function, which is “opened” later by revealing the argument(s), and many variations known in the art are believed suitable and would be readily recognized as appropriate for a particular application. The pre-images or arguments to the commit operation denoted by the function ƒ are a random value x created by the sender C, as described, the public key of C and the public key of D. When D receives the message of the first arrow it is presumably able to decrypt it using the Diffie-Hellman key and sync up with the message number. Various authentication, such as signatures and hash functions and other redundancy are optionally provided as is well known and can give D confidence that the message was received uncorrupted and has the corresponding sequence number encrypted into it.

The second message, this time in the opposite direction, from D to C, has potentially similar encryption and a payload that is the random value x′ created by D. Upon receiving and preferably checking whatever authentication on this message, C preferably sends preferably suitably encrypted message three to D that includes as payload the random value x that C used in forming message one. At this point, each party is able to construct the value y (=x′⊕ x), where the “⊕” dyadic operator denotes a combining function, such as a cyclic group operation. Thus, C and D each have participated in a process that gives them each a value. These two values are believed to be the same if there is no man in the middle present, and to differ with substantial probability if there is one, as has been mentioned. In some exemplary embodiments, not shown or described further for clarity, each party receives a commitment from the other before either party opens its commit.

In a first example application scenario for the embodiment of FIG. 2, devices 6a and 6b will be taken to be identical mappings from y into a “media” instance, such as text, sound, video, or combination that is preferably at least somewhat meaningful to the parties. As an example, for clarity, consider the media taken to be the text of a well-known quote. The quote is preferably made known to the parties A and B once y is known and it is determined, such as by being included in in-band communication, like the so-called “signature” of email messages. Then they communicate in whatever manner, as suggested by the inclusion of messages four and five, shown in each direction, and generic payload message content m₁ and m₂, respectively. It is believed that parties A and B, potentially desirous of determining whether there is a man in the middle and/or for whatever other reason(s), during the communication make some reference(s) to the quote. If there is a man in the middle, then it is likely that two different values for y were arrived at and that two different quotes resulted. It will readily be appreciated how references from one or the other party to its quote would be noticed as inconsistent with the quote known to the other party and the man in the middle thus detected.

In a second example application scenario for the embodiment of FIG. 2, devices 6a and 6b will be taken to be identical game applications, such as two-party game software chosen and/or taking input parameters from sequential parts of y. For instance, in one example, two communicants wish to “flip a coin” to decide what to do or who will do what, such as where to meet or who will perform which part of the process. They obtain, in one example, through out-of-band communication (not shown for clarity) with their own respective devices 1c and 1d, the result of the coin-flip game it creates. Each learns the same result determined by y if there is no man in the middle; but, if there is a man in the middle, it is believed that the different values of y held by C and D yield, with some probability, different results. The participants are assumed likely to learn when the results of the game differ. Some example games involve multiple steps, rounds or hands, as is well know, many messages or streams are communicated in some examples, and multiple games are anticipated over the course of the use of the key pair.

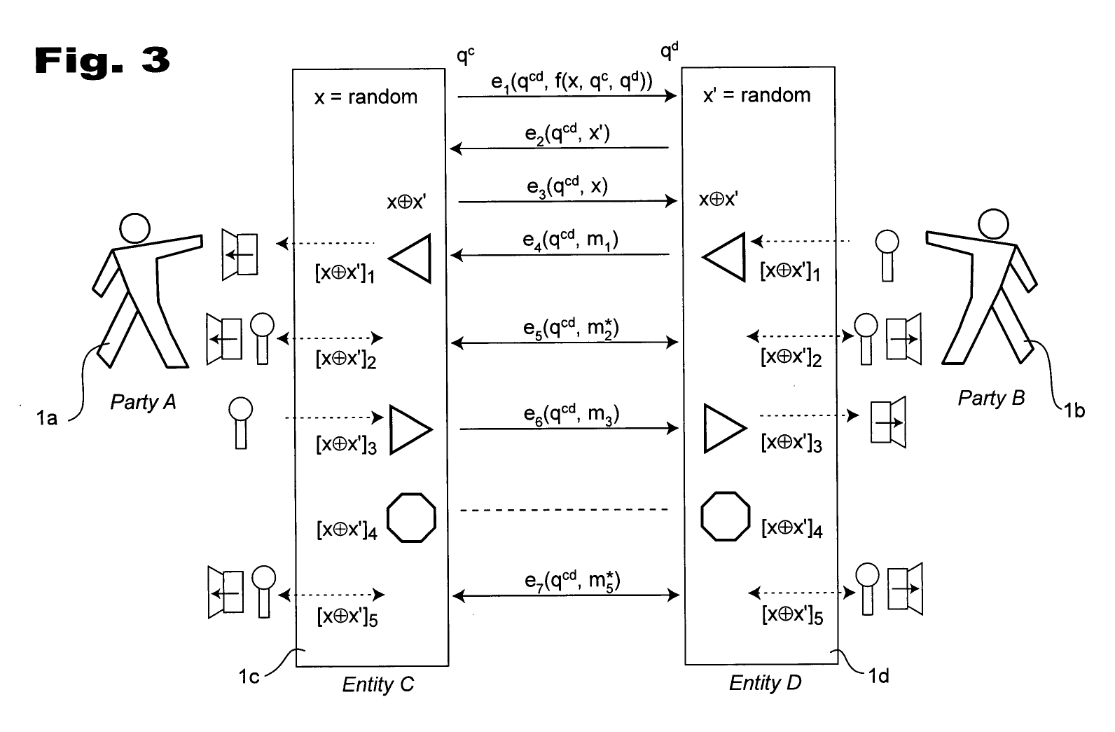

Turning now to FIG. 3, a combination block, functional, protocol, schematic, flow, plan diagram of exemplary random communication pattern systems in accordance with the teachings of the present invention will now be described in detail. Shown are the two communicating parties 1a and 1b, referred to as A and B. Also shown are their respective devices, entity 1c and 1d, called C and D, and public keys q^{c} and q^{d}, for each party, all as already described with reference to FIG. 2. A randomized protocol, also related to that already described with reference to FIG. 2, is shown as comprising the first three arrows from the top. The result is the random value, that will be referred to here as y (=x′⊕ x) known with identical value to both C and D if there is no man in the middle.

Each part of y, written as y₁, y₂, and so forth, determines one of, in the exemplary embodiment, four configurations. The first configuration shown corresponds to communication only in the direction from B to A, and is symbolized for mnemonic convenience as an equilateral triangle with a horizontal axis of symmetry and pointing towards party A. (In the example instance shown, this configuration corresponds to y₁.) Similarly, the third configuration corresponds to communication in the opposite direction and has its symbol flipped around the vertical. The second configuration has the empty symbol and corresponds with unrestricted communication between the participants, such as messages in both directions or interactive real-time voice and video. The fourth configuration has an octagon as its symbol and disallows communication in either direction.

In operation, each of the two devices 1c and 1d create respective random values x and x′ at least substantially unpredictable to others and uses them to form the first three messages exchanged. Users 1a and 1b optionally are substantially uninvolved in this process, although each may have consented to or initiated it as part of a policy and/or observed that it is underway using input output 5a and 5b. More specifically, a first encrypted message, using a first encryption function e₁ is shown using the key q^{cd} and having payload that is commit operation ƒ applied to the triple x, q^{c}, q^{d}, similar to that already explained with reference to FIG. 2. The second message, from D to C, shows similar parameterized encryption for its message number and payload x′. Again similarly encrypted message three has payload x. Thus C and D compute the same random value y when there is no man in the middle.

Referring now to the operation of the messages after the first three arrows, each subsequent arrow corresponds to a particular yᵢ known to both C and D. This value then preferably determines the direction(s) of communication, if any, that will be allowed during the corresponding time interval. The directions and timing preferably being provided to the user additionally through optional output 5a and 5b.

When user B begins during the first interval, providing input through transducer means shown as a microphone for simplicity (being only one potential function of transducer 4b, shown separately for diagrammatic clarity, as will be appreciated), this is conveyed through the fourth encrypted message formed by D and transmitted to C and received by C and decrypted by C and output by C to user A, as symbolized by the loudspeaker symbol, according to the restriction checked by C imposed by y₁. (The dashed arrows are intended to symbolize the flow of human communication into and out of the devices, again for diagrammatic clarity as will be appreciated.) The processing of the second time interval is similar, except that it uses the corresponding parameter “2” in the encryption, includes messages in either direction (as indicated by the double-ended protocol arrow in this case and the m* notation) shown as being received by microphones for A and B and also provided to them by respective loudspeakers. The third interval is similar to the first, except that the roles of the participants A and C are exchanged for those of the participants D and B. During the fourth time interval, y₄ informs devices 1c and 1d not to forward communication in either direction, and this missing message traffic is depicted by the dashed line. The final example interval shown is unrestricted, similar to the third.

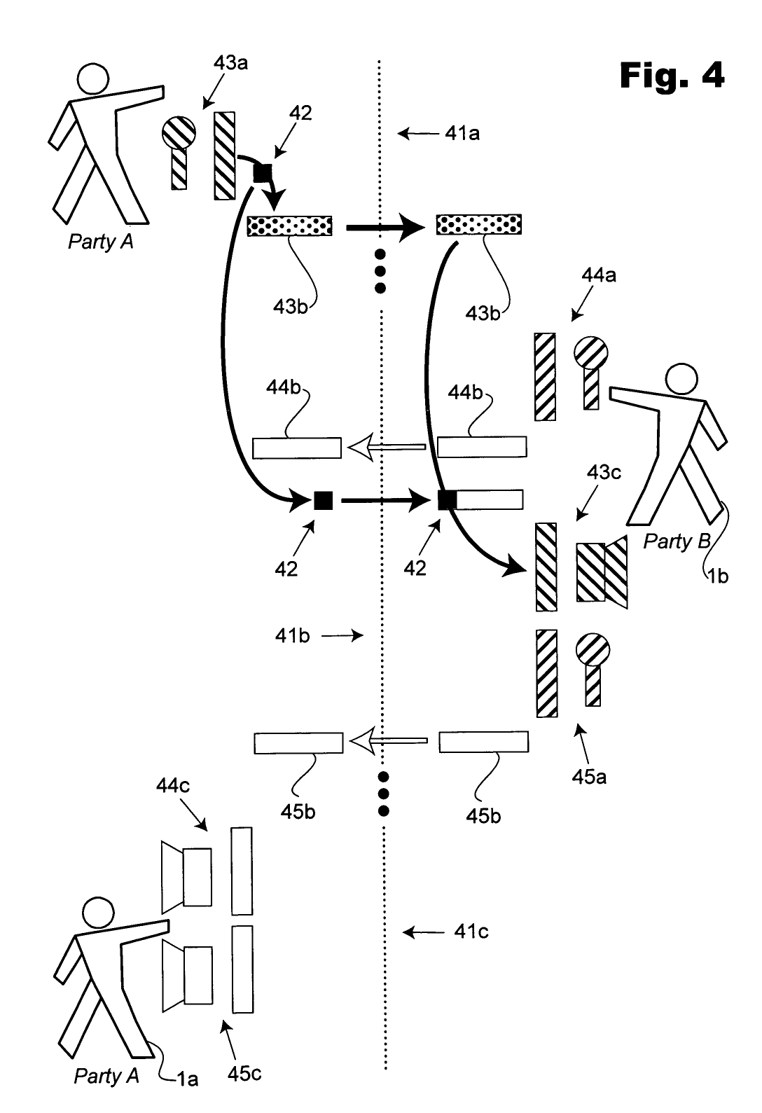

Turning now to FIG. 4, a combination functional, protocol, schematic, flow, plan diagram of exemplary communication order systems in accordance with the teachings of the present invention will now be described in detail. A two-party protocol, involving parties 1a, A, and 1b, B, is shown with time running vertically down between them in three phases: 41a, the setup before the first ellipsis; 41b, the response between the two ellipses; and 41c, the recovery after the second ellipsis.

During the setup phase A provides a message using input means, shown as a microphone for clarity, being a part of input output means 4a, already described with reference to FIG. 1, and also comprising an input buffer shown as a vertical block, such buffering used to some extent in typical audio and video systems at various stages and shown explicitly here for completeness. The message 43a is encrypted using key 42 and resulting in encrypted form 43b that is sent to equipment D of party B and waits there for processing during the second phase.

The notation for encryption, used for clarity as will be appreciated, has the following conventions: each key copy is depicted as a black square; the passage of a line through such a square represents encryption or decryption of the data on the line passing through; decryption being indicated unless an arrow is shown bringing the key to the square, in which case decryption is indicated. It will also be appreciated that the messages shown without encryption are preferably also encrypted and optionally authenticated, as elsewhere here, such as using the public keys present, by means not shown for clarity.

Some time later, symbolized by the first ellipsis, the response phase begins when B, inputs a first message 44a using input means symbolized by microphone and input buffer shown. The message 44a is presumably forwarded by D to C and stored by C for use in the next phase. Then C sends key 42 to D, which uses the key to decrypt message 43b stored and then to play it to B as shown by buffer and output means 43c. After receiving message 44a, B creates a reply message 45a, as symbolized by the microphone and its input buffer. This message is then sent as 45b from D to C.

Some time still after the second phase, symbolized by the second ellipsis, the recovery phase begins when A receives message 44b and 45b, as transformed by play out means 44c and 45c, respectively. If the time represented by the ellipses is significantly greater than that recorded by C as the interval between receipt of 44b and issue of 42 and/or between receipt of 44b and 45b and/or between release of 42 and receipt of 45b, then it is believed that A should have significant confidence in the absence of a man in the middle to the extent the messages received prove to be valid and appropriate.

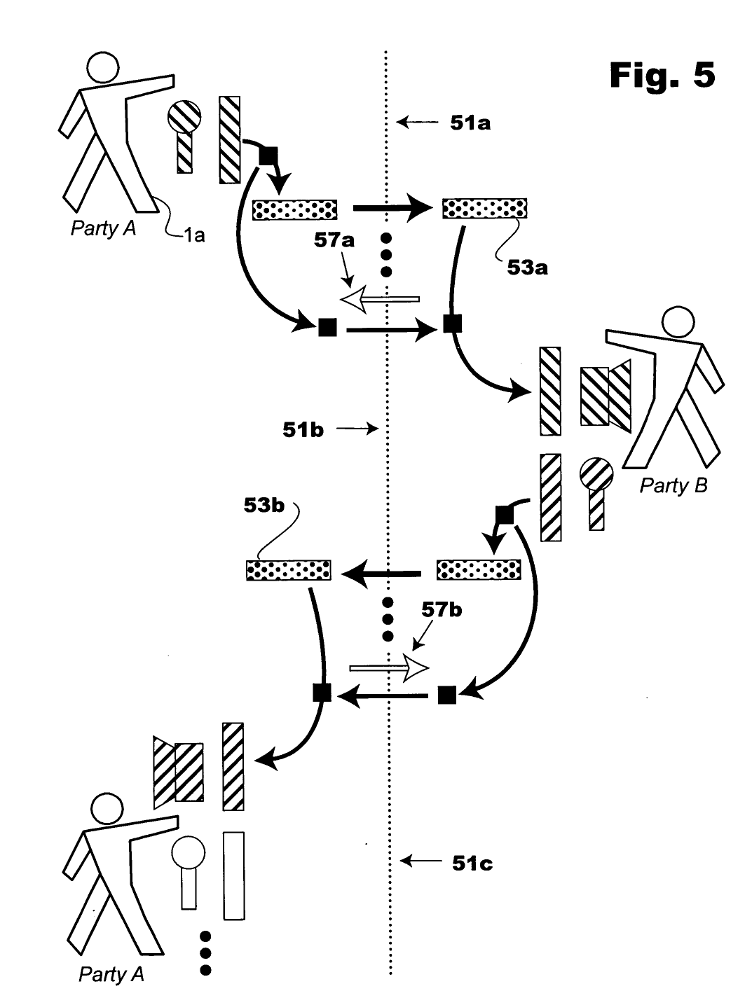

Turning now to FIG. 5, a combination functional, protocol, schematic, flow, plan diagram of exemplary communication timing systems in accordance with the teachings of the present invention will now be described in detail. This is shown using the example of a two-party ping-pong style protocol, involving parties 1a, A, and 1b, B, with time running vertically down between them. Two main example phases are shown in detail: 51a, the initial setup by A before the first ellipsis; and 51b, between the upper two ellipses shown is a typical intermediate interaction by B. Also, for completeness, a first part of an intermediate phase by A is shown as 51c after the second ellipsis, making the protocol ready to be repeated. The third ellipsis indicates that the ping-pong interaction optionally continues on, as with a series of email, chat, or voicemail, or videomail messages and responses.

Many of the component parts are similar to those in FIG. 4, and detailed numbering of them is reduced here for diagrammatic clarity, as will be appreciated. Primary differences of FIG. 4 with respect to FIG. 4 include: the request made by B for the key 57 from A is made without sending message content; no unencrypted message content is transmitted; and the order of messages is sequential and not overlapping, one is authored, encrypted, and decrypted, before the next message begins the cycle. In the example, the time sequence is: a first party creates a first message, encrypts that message, and sends that message; the second party then requests the key for the encrypted message, the first party sends the key, the second party gets the key, and the second decrypts the message with key; and the whole process repeats with the parties interchanged, beginning with the creation of a second message.

In operation, during the first phase 51a, A authors a first message into input means and buffers shown, as in FIG. 4. A first key is created by C and used by it to encrypt the first message, which encryption 53a is then sent to D. Later, during the second phase 51b, a request 57a is initiated, presumably initially by B or from some behavior of B, that causes C to send the first key to D and lets D decrypt message 53a and play it to B. After obtaining the first message content, B provides a presumably responsive second message, through means symbolized by microphone and buffer, to D. Then D creates a second key, encrypts the second message with it, and provides the encrypted message 53b to C. Later, in the third phase 51c, when A requests 57b the key for message 53b, the key is sent and A receives the message content from C. At this point A presumably prepares another message to send, and the cycle begun by A at the top of the figure is copied during each subsequent repetition.

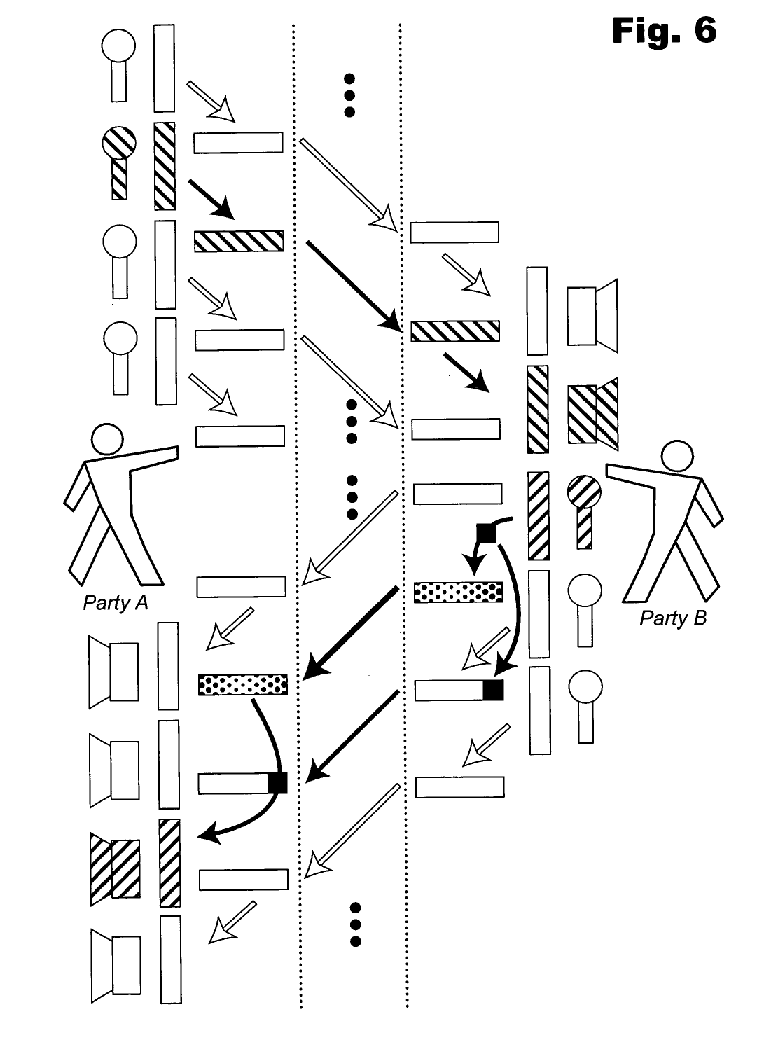

Turning now to FIG. 6, a combination functional, protocol, schematic, flow, plan diagram of exemplary communication latency systems in accordance with the teachings of the present invention will now be described in detail. Shown in the example, for clarity, are some example but representative messages in both directions comprising a real-time communication system, adapted to incorporate man in the middle protection. As with FIGS. 4 and 5, shown is a vertical time sequence with party A and C on the left and D and B on the right. Two dotted vertical lines, in stead of the single such line used in the other two figures, are intended to connote the accepted maximum time delay between leaving C and arriving at D, which is taken for clarity as the same as the maximum time delay between leaving D and arriving at C. In such systems there are typically two periodic series of packets, those traveling from left to right and those from right to left. Such series of packets appear cascaded when time is also used to arrange items horizontally, as shown. Thus, while one packet is being transmitted, its predecessors are being decoded, variously buffered, and played; and its successors are being captured, buffered, encoded, and formed. The diagram shows, for clarity, some of the left-right series above and some of the subsequent right-left series below, so as not to overlap the two directions for clarity, but to include enough detail for those of skill in the art to readily appreciate the process. Apart from the encryption, keys, and decryption, the process will be appreciated as substantially conventional and known.

The upper half of the diagram, as mentioned, includes input from A and output to B; the lower half, input from B and output to A. The input and associated buffering use substantially the notational conventions already introduced in FIGS. 4 and 5. Similarly, the output and buffering are comprised of the components introduced in the same two preceding figures. Moreover, the way encryption keys, encryption, and decryption, were shown in those figures is again used here. The ellipsis pairs in the middle indicate that the pattern shown in the upper half in fact covers the whole time period and, in fully overlapping fashion, so does the pattern shown in the lower half, all as mentioned. The upper and lower ellipsis indicate that the real-time messaging covers the participants' communication over whatever time interval.

The hatched fill pattern is again used to indicate the direction of messages, but unlike FIGS. 4 and 5, here it is used to draw attention to a single packet (out of a whole series, but in each stage of it passing through the cascade mentioned) sent by A and the immediately following and typically responsive packet sent by B. Those from A are hatched upper left to lower right; those from B, upper right, lower left. A delay encryption of one packet time is shown, using the notation of FIGS. 4 and 5. In particular, D encrypts the hatched microphone input packet and sends the key for it in with the next packet in sequence. Thus, when C starts decrypting this packet, the packet was already waiting a packet time (apart from jitter buffer delays, as will be appreciated by those of skill in the packet streaming art). It will be appreciated that such delay can be adjusted to more than one packet, by including the key in a later packet. It will also be appreciated that no such delayed opening encryption is shown in the direction from A for diagrammatic clarity, but whatever delay in that direction can also be included. When C and/or D introduce one or more packet delays, the overall “latency” of the communication system is thus increased. Human users are known to be sensitive to latency in real-time communication, from noticing it above certain levels to being annoyed by it at higher levels, to finding it difficult to communicate at even higher levels (as mentioned earlier).

It will be appreciated that the so-called round trip latency is the sum of that included by C and that by D. In the example, none is added in one direction and one packet time is added in the other. Any number of delays can be included in each, preferably adjusted so that the system works adequately under worst-case communication channel characteristics. The amount of round trip delay added in this way is believed to cause a man in the middle to have to introduce an additional equivalent amount of delay, thereby doubling the added delay. It is believed that this increase in latency will be noticeable to users A and B (as mentioned described more generally earlier), and thus one or both would become aware of the man in the middle.

In some exemplary embodiments, the amount of delay added is changed by the two counterparties in synchrony in such a way that the sum preferably remains substantially the same. The pattern or schedule of changes, which are preferably gradual, is however preferably dictated by a common but random value. This value is preferably taken to be like y in the embodiments of FIGS. 2 and 3, so that without a man in the middle, both C and D would have the same value of y; but with a man in the middle, C and D substantially would differ. Thus, in the case of man in the middle, there are likely times when both C and D introduce the maximum delay, creating a doubling of the delay (though for limited periods) compared to the delay that would be present uniformly without a man in the middle.

Changing the amount of delay dynamically, however, can cause gaps in the content. Increasing the delay by a sender means that there will be a period during which the recipient will not be able to receive content; decreasing the delay by a sender means that there are two snippets of content available for play at the same time by the recipient. Because the changes in delay are gradual and preferably scheduled, there is believed time to prepare for them by “stretching out” or “shrinking down” the content being played. One packet today is typically 20 ms of content and shifts might allow, for instance, a number of seconds for such a change. Known techniques, such as so-called “time compressed speech,” allow speech to be stretched or shrunk by a factor of two; here, a much smaller factor is required, such as a around one percent. For compressed audio, the so-called “key frame” approach currently employed apparently allows for readily spreading a time shift over several frames between the so-called key frames. The algorithmic derivation of the schedule from the random value is thus preferably such that transitions are gradual enough, such as several seconds for a 20 ms packet shift (as an example set of parameters), and that overlaps of several seconds while both parties are at maximum injected latency are frequent enough for the security requirements.

Turning now to FIG. 7, a combination block, functional, protocol, flow, schematic, diagram of exemplary mutual communicant discovery and authentication systems in accordance with the teachings of the present invention will now be described in detail. Shown are three parties: communicants C and D, as elsewhere, and an exemplary mutual communicant Z, that has established authenticators separately with C and with D. In some examples, such authenticators are established when communication between a pair of participants convinces each that there is not MITM and optionally that the counterparty is worthy of such by whatever criteria.

The three parties are each shown as a box labeled by their respective public keys, q^{c} for party C, q^{d}, for party D, and q^{z} for party Z. Each party is shown as knowing their respective private exponent, c, d, and z, by the exponent appearing within their box. Also shown within the corresponding boxes are some example authenticators that have been established; those with the so-called prime “′” symbol are from other interactions and included here to illustrate exemplary non-matching authenticators. Other authenticators known to Z, not used elsewhere in the description, are omitted for clarity through ellipsis, as will be appreciated. In particular, the matching authenticators are those shown corresponding to the lines between each communicant party and the mutual party Z: W^{cz} and W^{dz}. These were established between the two parties on each end of the line they label by a respective call to an establish sub-protocol, an example of which being provided here in FIG. 10, to be described.

Referring now to the detailed interaction protocol between patties C and D shown, messages are shown using an arrow notation common to FIG. 7 through FIG. 11. All messages in the protocol descriptions related to FIG. 7 through FIG. 11, unless otherwise mentioned, are preferably encrypted and authenticated, as will be readily appreciated by those of skill in the art. The values shown separated by commas and/or semicolons are preferably sent separately, such as in fields of a message format or data description language, as are well known in the software messaging art.

In particular, there are four messages. The first comprises two values, W^{dz′} and w^{dz}, sent by party D to party C. These are candidate authenticators, any of which D is presumably willing to use if C has a matching value; whether a matching value is known, and/or which value it is, is presumably not known at least with certainty to D and/or D is not willing to admit this C. Similarly, the first part of the corresponding reply message from C to D contains three candidates (up to the semicolon): W^{cz″}, W^{cz}, W^{cz′}. After the semicolon the message contains the so-called one-way function h applied separately to two values: the first value is the first candidate from D in the first message and the second value is the second candidate in that message: W^{dz′} and w^{dz}.

At this point it will be appreciated that party D will raise each value in the first part of the second message to d, the secret key of D already mentioned as shown. Then D applies the function h already mentioned to the result of each such exponentiation and checks for a match with any of the images under h in the second part of the first message. It is believed prudent for D to reveal such images or other partial information as an example approach to not providing a so-called “oracle” for the power c, as is known in the art. If there is a match, then a mutual party is suggested.

It will be appreciated, however, that D is believed potentially unsure at this point of whether C really was the counterparty of the mutual party; similarly, even when D shows the matching value, C presumably is believed potentially unsure at that point whether D really was the counterparty of the mutual party. Accordingly, each of C and D provide a so-called interactive “proof” to the other that the power they used corresponds to that on their public key. An exemplary proof sub-protocol is introduced and detailed with reference to FIG. 11, as will be explained. It establishes that the power relating the first pair of arguments is the same as that for the second pair. Thus, it is believed, that after the proofs shown, each of C and D is sufficiently convinced that their counterparty participated in establishment of the proffered authenticator using their proffered public key. Multiple matches are anticipated and would preferably also be accompanied by corresponding proofs, not shown for clarity. The proof protocol, and hence its invocation as a sub-protocol, also discloses each of the four values that it is showing the relationship between.

Referring now to FIG. 8, a combination block, functional, protocol, flow, schematic, diagram of exemplary privacy-enhanced mutual communicant discovery systems in accordance with the teachings of the present invention will now be described in detail. The system already described with reference to FIG. 7, however, does reveal the proffered authenticators to the counterparties—and also reveals which authenticators match. The system of the present FIG. 8 enhances privacy of the parties by, it is believed, avoiding revealing these aspects unless the parties wish to.

The three parties again are each shown as a box labeled by their respective public keys, q^{c} for party C, q^{d}, for party D, and q^{z} for party Z. Each party is shown as knowing their respective private exponent, c, d, and z, by the exponent appearing within their box. Also shown within the corresponding boxes are some example authenticators and those with the prime “′” symbol and again comprise exemplary non-matching authenticators. The matching authenticators are those shown corresponding to the lines between each communicant party and the mutual party Z: W^{cz} and W^{dz}. These were established between the two parties on each end of the line they label by a respective call to an establish sub-protocol, an example of which being provided here in FIG. 10, to be described.

Privacy enhancement is believed in part owing to two exponent values, a and b, chosen from suitable distributions preferably substantially uniformly at random, by parties C and D, respectively, as shown using the equality symbol “=” to denote assignment of a suitable random value to the local variable. For optimal privacy, it is believed these values are nor re-used across transactions, thereby it is believed also hiding the relationship between candidates used in different transactions. Each party will be said to here “obfuscate” its candidate values using its secret random exponent, meaning that it substantially hides the candidate values from those without the corresponding keys.

The first four messages are similar to those of FIG. 7 and there are two additional proof messages related to the obfuscation parameters. The first again comprises two candidate authenticator values, W^{dz′b} and w^{dzb}, sent by party D to party C; here they include the additional factor b in the exponent compared to the corresponding values already described with reference to FIG. 7. Again similarly, the first part of the corresponding reply message from C to D contains three candidates with the obfuscating exponent a: W^{cz″a}, W^{cza}, W^{cz′a}. And again the message also contains h applied separately to the candidates from the first message: W^{dzb′} and w^{dzb}. Similarly party D raises each value in the first part of the second message to the db power and applies h to the separate results and checks for a match with any of the values in the second part of the first message.

The motivation for convincing that the exponents are know is similar to that already described with reference to FIG. 7. Here, the additional obfuscation parameters are shown to be known but are not revealed. The combination of the two proofs in the same direction are believed to establish that one power used is that corresponding to the public key and that the obfuscation power is known. It will be appreciated by those of skill in the art that a sub-protocol establishing that a and b are substantially out of control of C and D, respectively, can be readily devised and optionally offers additional protection against colluding parties. An example being a so-called “cut and choose” where many candidate factors for an obfuscation parameter are presented as powers of q and then half chosen by the counterparty are shown to have exponent chosen as the result of a suitable substantially one-way function.

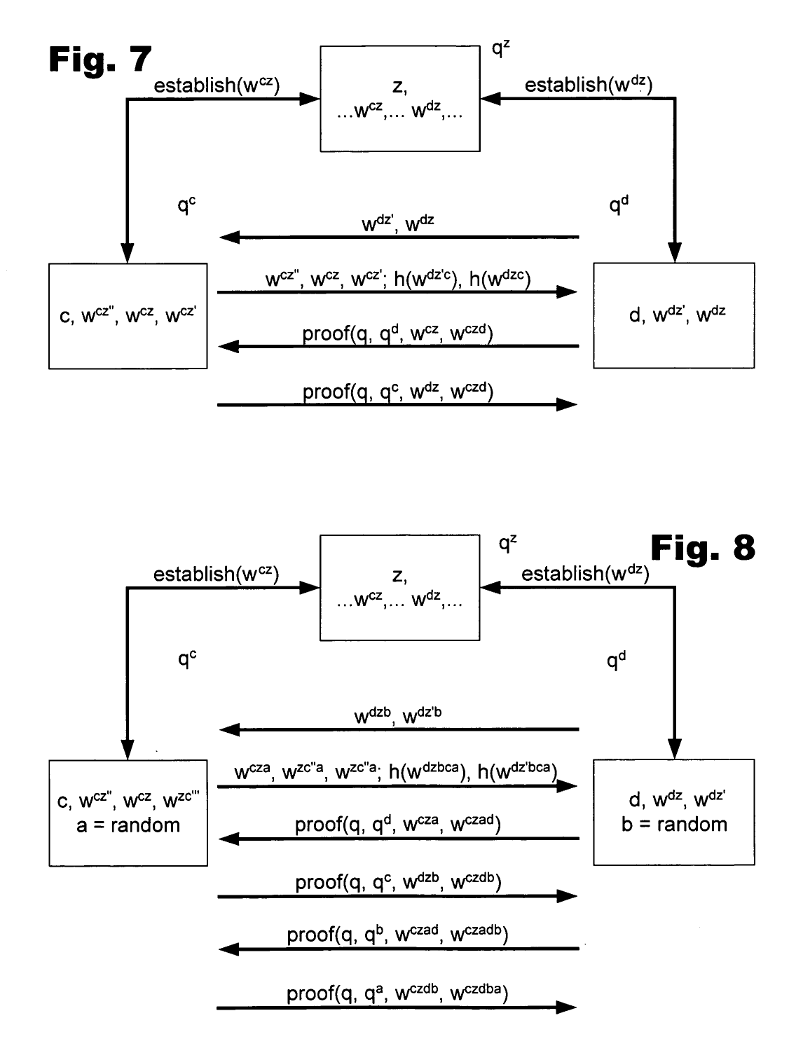

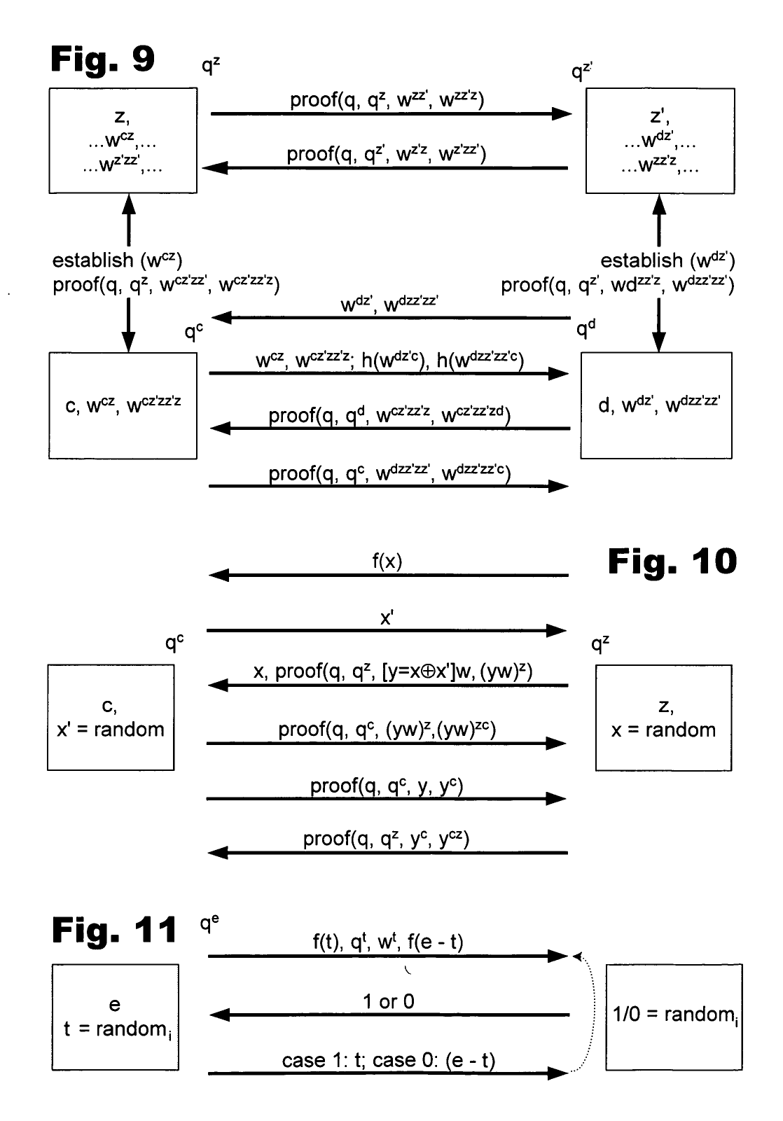

Referring now to FIG. 9, a combination block, functional, protocol, flow, schematic, diagram of exemplary friend-of-a-friend communicant discovery systems in accordance with the teachings of the present invention will now be described in detail. Shown are four parties: communicants C and D, as elsewhere, and exemplary “friend” communicants Z and Z′. Shown are three friend relationships, each with their own authenticators, that between C and Z, between Z and Z′, and between D and Z′. The authenticators corresponding to each friendship are established, in a manner similar to that already described with reference to FIG. 7 and FIG. 8, when communication between a pair of direct friends convinces each that there is not MITM and optionally that the counterparty is worthy of such by whatever criteria. Also indicated are additional authenticators, W^{cz′zz′z} and W^{dzz′zz′}, on which a proof sub-protocol is applied, that are particularly for the friend of a friend discovery. These additional authenticators are shown as based in turn on what will be called “tell a friend” authenticators exchanged between Z and Z′ along with corresponding proofs as shown.

The four parties are each shown as a box labeled by their respective public keys, q^{c} for party C, q^{d}, for party D, q^{z} for party Z, and q^{z′} for party Z′. Each party as before is shown as knowing their respective private exponent, c, d, z, and z′ by the exponent appearing within their box. Also again shown within the corresponding boxes are some example authenticators with others omitted for clarity shown using ellipsis. The pairwise authenticators are shown corresponding to the lines between parties C and Z as W^{cz} and between D and Z′ as W^{dz′}, established by a respective call to an establish sub-protocol as already described, such as with reference to FIG. 7. Additionally, the friend-of-a-friend authenticators are also shown corresponding to the lines between parties C and Z as W^{cz′zz′z} and between D and Z′ as W^{dzz′zz′}, also established by a respective call to a proof sub-protocol and each based on a corresponding tell-a-friend authenticator.

The lower four horizontal arrow lines of the protocol are much as already described with reference to FIG. 7 (with a variant along the lines of FIG. 8 is anticipated but omitted for clarity.) The difference being substantially the inclusion of the friend-of-a-friend authenticators just described. In the example, these are the two that are shown as matching; that is, when each of C and D apply their respective secret exponent to the candidate they obtained from the other party the result is the same, as indicated in the first two of the four arrows. Recognizing the match, as in FIG. 7, the proofs in the last two of the four arrows are based substantially also as in FIG. 7. However, it will be appreciated that both participants recognize in the example that the authenticator involved, at least from their side, was obtained as a friend-of-a-friend, and not as a mutual-friend, authenticator, because of the different sub-protocol used to receive each type as mentioned. It is believed that an optional feature is that if the underlying public exponents are arrived at or established to be free of multiplicative relations, then the friend-of-a-friend approach establishes the unique key much as the mutual-friend approach.

Turning now to FIG. 10, a combination block, functional, protocol, flow, schematic, diagram of exemplary sub-protocols for establishment in accordance with the teachings of the present invention will now be described in detail. The two participants in this sub-protocol, taken for example as a part of that already described with reference to the left call in FIG. 7, are C and Z. Other authenticators are not shown for clarity and each participant, C and Z, forms a value at random, shown as x′ and x, respectively, similar to the a and b values already described with reference to FIG. 9.

These random values are exchanged using the one-way function ƒ, and a mutually random value shown as y (=x′⊕ x) is created in the first three protocol arrows shown. Additionally, in the third arrow, the product of y and w is revealed and proved by Z to C as being raised to the z power. Then, in the fourth arrow, C responds by revealing the c power of the proven power of (yw)^{zc}. In the fifth arrow C reveals y^{c} and proves to Z that it is properly formed. This then allows Z to respond in the final arrow with the value y^{cz} through its proof of being well formed. At this point, both C and Z can form the multiplicative inverse of y^{cz} and multiply the earlier established value (yw)^{zc} by this to recover the desired authenticator yw^{zc}.

Referring finally now to FIG. 11, a combination block, functional, protocol, flow, schematic, diagram of exemplary sub-protocols for proof to convince of transformation correctness in accordance with the teachings of the present invention will now be described in detail. The two participants in this sub-protocol are taken to be generic parties, as the protocol is used between various pairs of parties in the preceding descriptions of FIG. 7-10. One party, the so-called “prover,” has public exponent q^{e} and corresponding private exponent e, as shown according to the conventions of the other diagrams. The counterparty, known as the “verifier,” does not use a public key as an inherent part of the protocol, and so is shown without such a key. Each of the two parties is creates random values, one such value for each value taken on by index i that is varied for each iteration of the sub-protocol used to increase confidence in its result, as is known. The prover creates random exponents shown at t; the verifier chooses at random from one and zero.

The first arrow indicates four values transferred from the prover the verifier. The first is the image under the one-way function, shown for clarity as the same ƒ, of the random value t chosen for this ith iteration, as mentioned. Also the fourth value is an image under ƒ of the difference between exponents e and the value of t for this iteration. The middle two values are tth powers of q and w, respectively. Once the first message is received by the prover the verifier provides a random bit value, either a one or a zero, called a “challenge,” chosen by the prover at random for this iteration, as mentioned. There are two cases for the third arrow response by the prover to the verifier. In case the challenge bit has value one, then the prover is to reveal t; in the other case, challenge zero, the difference of e and t is revealed. The four steps are repeated with separately generated random values as many times as desired, such as one hundred times, for example. It will be appreciated, however, that various known techniques allow substantial economy of transmission shifts, bandwidth, and computation to be applied to multiple instances of such sub-protocols and including multiple instances of the sub-protocols invoked by the protocols with the same participants that rely on such sub-protocols.

Consider the first case, challenge one. The prover reveals the value t and thus allows the verifier to check that the first value was in fact formed as its image under ƒ and that the second and third values, q^{t} and w^{t}, of the first arrow were in fact formed properly. Now consider the second case, challenge zero. The prover reveals e-t, this time allowing the second image under ƒ to be verified and each of the second and third values to be combined with a power of the respective base values, q and w, such that the result is q^{e} and w^{e}, respectively.

All manner of variations, modifications, equivalents, substitutions, simplifications, extensions, and so forth can readily be conceived relative to the present inventions by those of ordinary skill in the art. One example, as will be appreciated, is including more than two communicant parties. Another example is the use of so-called “time compressed speech” and/or video to allow a user to catch up to what the counterparty has been communicating beginning after a request by the communicant for the opening of messages.

While these descriptions of the present invention have been given as examples, it will be appreciated by those of ordinary skill in the art that various modifications, alternate configurations and equivalents may be employed without departing from the spirit and scope of the present invention.

What is claimed is:

1. A communication system for use by at least two communicants that allows them to detect a man in the middle intermediary in their communication through substantially normal communication.

2. The system according to claim 1, further comprising: the development of a substantially random value by interaction of the two communicants and where the value is the same for the communicants absent a man in the middle and where it is substantially likely different in case of a man in the middle.

3. The system according to claim 1, further comprising: committing to messages by at least one of the communicants, opening of at least one committed messages upon receipt of a corresponding message from a second of the communicants, and consideration of at least the relative timing of the communication.

4. The system according to claim 1, further comprising: a first of the parties forming committed messages and the first party opening at least some of the committed messages responsive to a second of the parties and by consideration of at least the relative timing of the communication by the first party.

5. In the system of claim 4, including said second party also forming committed messages and the second party opening at least some committed messages responsive to said first party and by consideration of at least the relative timing of the communication

6. A communication system according to claim 1, comprising the introduction of latency by commitment and subsequent delayed release of keys for opening of message parts, such that at least one communicant substantially able to notice an increase in latency substantially due to the presence of a man in the middle.

7. In the system of claim 6, including changing the latency introduced by each communicant based on at least a value that is random and substantially the same for the two communicants absent a man in the middle and the value substantially likely substantially different in case of a man in the middle.

8. In the system of claim 7, where communication is substantially real-time interactive.

9. A system allowing each of at least two communicants to discover if at least some communicants have confirmed their keys.

10. In the system of claim 9, where at least one of the said communicants can discover if at least a mutual third-party communicant has confirmed keys of both said communicants.

11. In the system of claim 9, where the identity of least some candidate third communicants are hidden.

12. In the system of claim 9, where the identity of a common candidate can be revealed.

13. In the system of claim 9, where at least one of the said communicants can discover if a first third-party communicant has confirmed the key of the first communicant and a second third-party has confirmed the key of the second communicant and at least the first third-party has confirmed the key of the second third-party.

14. A communication system for use by at least two communicants that allows at least one of the communicants to detect a man in the middle intermediary in their communication.
